(19) United States
(12) Patent Application Publication
(10) Pub. No.: US 2015/0106724 A1
(43) Pub. Date: Apr. 16, 2015

(54) METHOD OF VISUALLY INDICATING OPTIMAL COMMUNICATION TIMES

(71) Applicants: MICHAEL T. DONNELLY, ARLINGTON, VA (US); ERIK S. LABIANCA, ASHBURN, VA (US)

(72) Inventors: MICHAEL T. DONNELLY, ARLINGTON, VA (US); ERIK S. LABIANCA, ASHBURN, VA (US)

(21) Appl. No.: 14/504,387

(22) Filed: Oct. 1, 2014

Related U.S. Application Data
(60) Provisional application No. 61/890,082, filed on Oct. 11, 2013.

(51) Int. Cl. H04L 29/08; G06F 3/0484

(52) U.S. Cl. CPC H04L 67/22; G06F 3/0484
USPC 715/738

(57) ABSTRACT

The method of visually indicating optimal communication times provides a visual indicator to a user of the most and least desirable times for communicating with a selected entity, such as an individual, a business or the like. At least one type of communication of the entity is monitored, and percentages of communications with each hour-long period of a 24 hour day are recorded. The types of communications may include e-mails, telephone calls, social media activity, and the like. Based on the percentages for each hour-long period, a color-coded scheme is applied to each of the hours in the 24-hour day. A visual representation of the 24 hour day is displayed to the user. Each hour-long period is displayed in its respective color, visually indicating to the user the most desirable and least desirable times to communicate with the entity.

### CROSS-REFERENCE TO RELATED APPLICATION

This application claims the benefit of U.S. Provisional Patent Application Ser. No. 61/890,082, filed Oct. 11, 2013.

### BACKGROUND OF THE INVENTION

1. Field of the Invention

The present invention relates to data collection and analysis, and particularly to a computerized method of visually indicating optimal communication times with an intended entity based upon collection and analysis of communication data.

2. Description of the Related Art

In such fields as marketing, sales, advertising, project management and the like, knowledge of when an intended recipient of communication is available and most likely to be receptive is quite valuable. In the past, such data analysis and demographics had to be conducted through polling, surveys and the like, most of which had to take place in person or via the mail. Such data collection and analysis was time intensive, required a large amount of manpower to implement, and suffered greatly from lost surveys, human error and the like. It would obviously be desirable to take advantage of modern, computerized communication methods to automate such data collection and analysis.

Thus, a method of visually indicating optimal communication times solving the aforementioned problems is desired.

### SUMMARY OF THE INVENTION

The method of visually indicating optimal communication times provides a visual indicator to a user of the most and least desirable times for communicating with a selected entity, such as an individual, a business or the like. At least one type of communication of the entity is monitored, and the number of times N that type of communication occurs within one hour of a particular day is recorded. The total number of times T that type of communication occurs within the entire particular day is also recorded. The type of communication may include e-mails, telephone calls, social media activity, and the like.

The percentage Pᵢ for each i-th hour of the particular day is then calculated, where is an integer ranging between 0 and 23, such that the percentage Pᵢ indicates an hourly percentage of the total number of times that particular type of communication occurred in the sampling day. This percentage is calculated as Pᵢ=(N/T)×100. A selected set of the percentages Pᵢ is displayed to the user.

Color codes are then assigned to each of the 24 hour-long periods. A first color, green, for example, is assigned to any of the i hours where Pᵢ for the corresponding hour is greater than 10; a second color, yellow, for example, is assigned to any of the i hours where Pᵢ for the corresponding hour is in the range 5≦Pᵢ≦10; and a third color, red, for example, is assigned to any of the i hours where Pᵢ for the corresponding hour is less than 5. A visual representation of a 24-hour period for the particular day is displayed to the user. The display is divided into 24 separate regions. Each region represents a corresponding one of the i hours. Each region is displayed in the respective color of the corresponding i-th hour, such that a region displayed in the first color indicates a desirable time period for communicating with the entity, a region displayed in the second color indicates a less desirable time period for communicating with the entity, and a region displayed in the third color indicates a least desirable time period for communicating with the entity.

In an alternative embodiment, the percentage Pᵢ for the i-th hour of the particular day is calculated and displayed to the user as in the previous embodiment, but a weighted percentage WPᵢ for the i-th hour of the particular day is also calculated, such that when k occurrences of the sampled type of communication occur within the i-th hour, a weighted number, N_{w}, is calculated as N_{w}=1+0.25(k−1). The weighted percentage WPᵢ for the i-th hour of the particular day is then calculated as WPᵢ=(N_{w}/T)×100. As in the previous embodiment, color codes are then assigned to each of the 24 hour-long periods, but in this embodiment the codes are based on the weighted percentage WPᵢ. The first color is assigned to any of the i hours where WPᵢ for the corresponding hour is greater than 10; the second color is assigned to any of the i hours where WPᵢ for the corresponding hour is in the range 5≦WPᵢ≦10; and the third color is assigned to any of the i hours where WPᵢ for the corresponding hour is less than 5.

These and other features of the present invention will become readily apparent upon further review of the following specification and drawings.

### BRIEF DESCRIPTION OF THE DRAWINGS

FIG. 1 is an exemplary screenshot of a first screen of a user interface of a computer software implementation of a method of visually indicating optimal communication times according to the present invention.

FIG. 2 is an exemplary screenshot of a second screen of the user interface of a computer software implementation of a method of visually indicating optimal communication times according to the present invention.

FIG. 3 is a block diagram illustrating system components for implementing the method of visually indicating optimal communication times according to the present invention.

Similar reference characters denote corresponding features consistently throughout the attached drawings.

### DETAILED DESCRIPTION OF THE PREFERRED EMBODIMENTS

The method of visually indicating optimal communication times provides a visual indicator to a user of both the most and least desirable times for communicating with a selected entity, such as an individual, a business or the like. At least one type of communication of the entity is monitored, and the number of times N that type of communication occurs within one hour of a particular day is recorded. A total number of times T that type of communication occurs within the entire particular day is also recorded. The type of communication may include e-mails, telephone calls, social media activity, and the like.

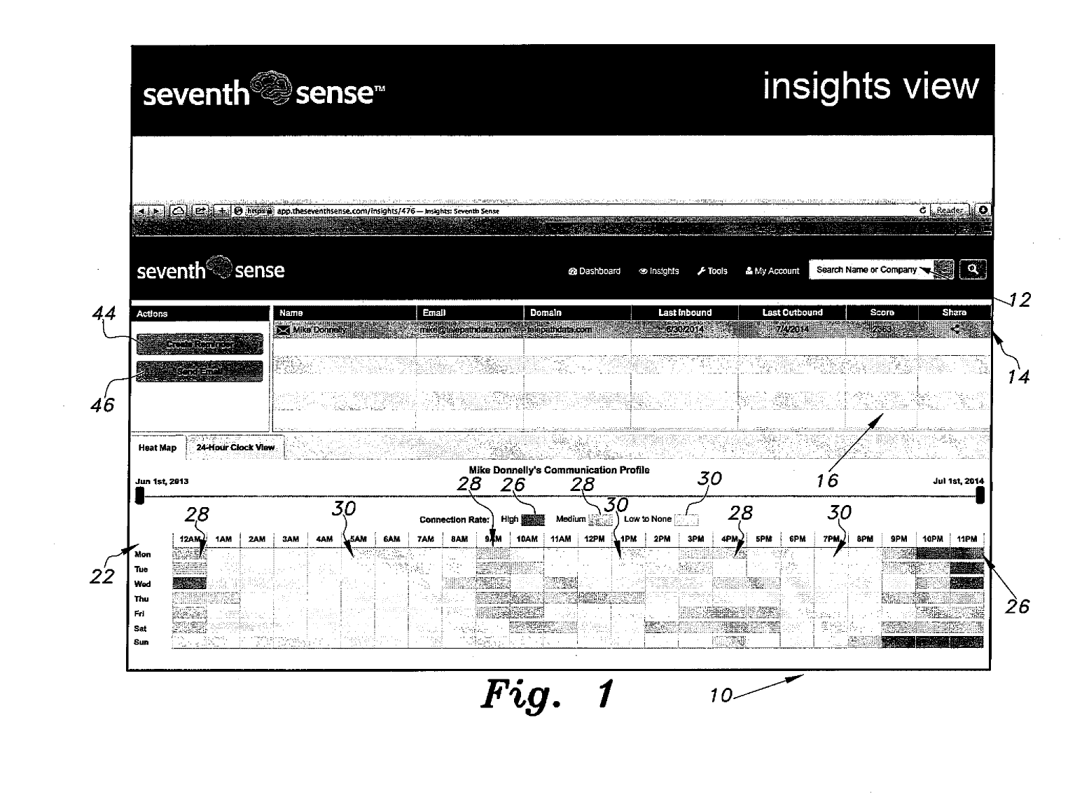

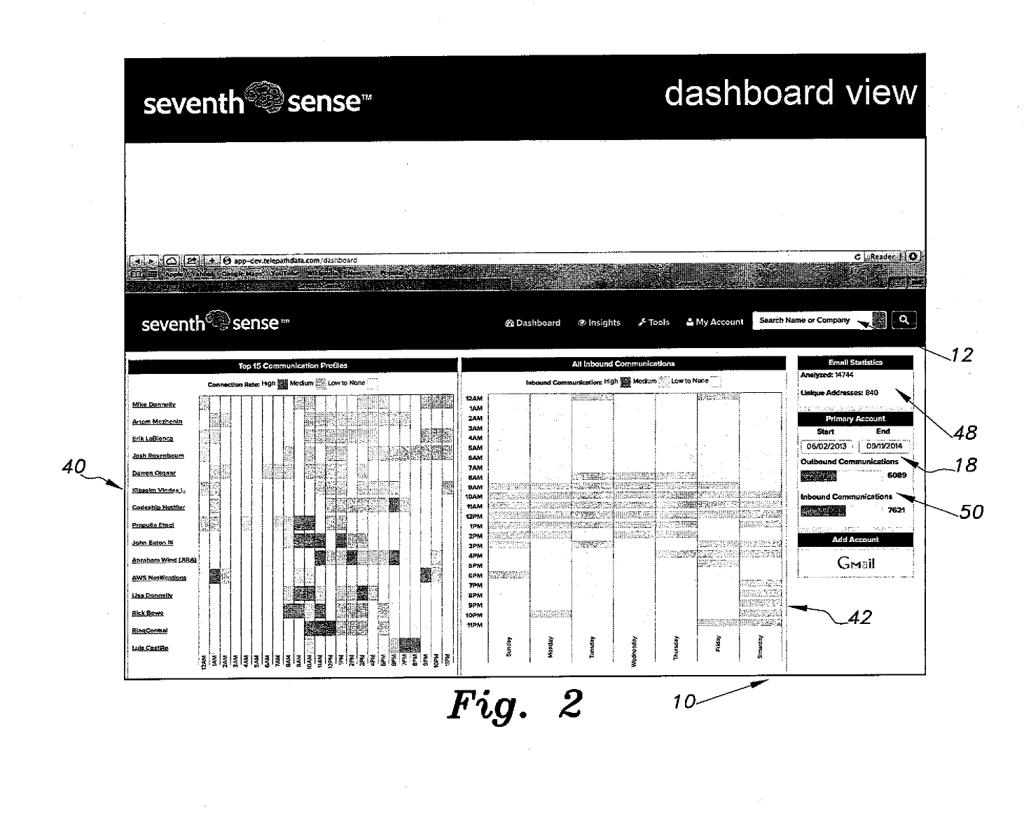

The percentage Pᵢ for an i-th hour of the particular day is then calculated, where i is an integer between 0 and 23, such that the percentage Pᵢ indicates an hourly percentage of the total number of times the at least one type of communication occurred in the particular day. This percentage is calculated as Pᵢ=(N/T)×100. A selected set of the percentages P, is displayed to the user. In the exemplary screenshot 10 of FIG. 1, illustrating an exemplary user interface for a software implementation of the present method, the user may search for a desired entity (either a particular online user or business) in box 12. Box 14 displays communications associated with the entity (in this example, e-mail communications have been selected), showing names, e-mail addresses and e-mail domains for each e-mail communication. It should be understood that in FIG. 1, only one listing, in the top row of box 14, is shown for clarity and illustrative purposes, though multiple such listings/rows may fill box 14. In column 16, a score, based on a number of “data points” of interest, is displayed; i.e., the scare is based on the number of times N (i.e., the data point value) that particular type of communication occurs within one hour of the sampling day. The subsequent screenshot of FIG. 2 shows a box 18, which allows the user to select a particular day and time of interest, or range of dates. Preferably, the user also may choose the type of communication (for example, e-mail, telephone call or social media). Additional information can be searched for inclusion in the data monitoring and gathering by a conventional search engine.

Button 44 allows the user to easily create a reminder alert or message, reminding the user to contact the entity of interest at the most desired time. Button 46 allows the user to integrate the system with a conventional email program for rapid and easy communication with the entity of interest. In FIG. 1, the system is directed solely to a single client or entity of interest. As shown in FIG. 2, the system may also display multiple entities in box 40 for purposes of comparison. In the example of FIG. 2, the entities selected are the top fifteen most active communication profiles. Box 42 shows a weeklong aggregate, displayed by hour, showing all inbound communication for statistical and comparative purposes. Additionally, various aggregated statistics may be displayed to the user. For example, region 48 shows general email communication statistics, specifically displaying the total number of email communications analyzed to generate the communication time preferences, as well as the number of distinct email addresses associated with the full set of communications. Region 50 displays a breakdown of the communications by number of inbound and number of outbound communications. It should be understood that any desired statistics may be displayed to the user.

Color codes are assigned to each of the 24 hour-long periods. A first color, green, for example, is assigned to any of the i hours where Pᵢ for the corresponding hour is greater than 10; a second color, yellow, for example, is assigned to any of the i hours where Pᵢ for the corresponding hour is in the range 5≦Pᵢ≦10; and a third color, white, for example, is assigned to any of the i hours where Pᵢ for the corresponding hour is less than 5. A visual representation of a 24-hour period for a particular day is displayed to the user. Alternatively, as shown in FIG. 1, a set of days, such as a week, may also be displayed for purposes of comparison, with each day displayed being divided into 24 separate regions. Each region represents a corresponding one of the i hours. Each region is displayed in the respective color of the corresponding i-th hour, such that a region displayed in the first color indicates a desirable time period for communicating with the entity, a region displayed in the second color indicates a less desirable time period for communicating with the entity, and a region displayed in the third color indicates a least desirable time period for communicating with the entity.

The color-coded display is illustrated in box 22 of the exemplary screen shot 10 of FIG. 1. In this particular example, a range of one week is presented to the user. Individual blocks are provided for each hour of each day of that selected week, ranging from Monday to Sunday, and each block receives an appropriate color code. As an example, looking at the row for Monday within box 22, color 26 represents green, indicating that the best times for the user to communicate with the entity on Monday are between the hours of 10:00 PM and 12:00 AM. The color 28 represents yellow, indicating the second best times to communicate with the entity, and the color 30 represents white, indicating the least desirable time to communicate with the entity. According to this display, the user should not try to communicate with the entity between the hours of 1:00 AM and 9:00 AM, 10:00 AM and 3:00 PM, and between 5:00 PM and 9:00 PM.

In an alternative embodiment, the percentage Pᵢ for the i-th hour of the particular day is calculated and displayed to the user as in the previous embodiment, but a weighted percentage WPᵢ for the i-th hour of the particular day is also calculated, such that when k occurrences of the type of communication occur within the i-th hour, a weighted number, N_{w}, is calculated as N_{w}=1+0.25(k−1). The weighted percentage WPᵢ for the i-th hour of the particular day is then calculated as WPᵢ=(N_{w}/T)×100. As in the previous embodiment, color codes are then assigned to each of the 24-hour long periods, but in this embodiment, the codes are based on the weighted percentage WPᵢ. The first color is assigned to any of the i hours where WPᵢ for the corresponding hour is greater than 10; the second color is assigned to any of the i hours where WPᵢ for the corresponding hour is in the range 5≦WPᵢ≦10; and the third color is assigned to any of the i hours where WPᵢ for the corresponding hour is less than 5.

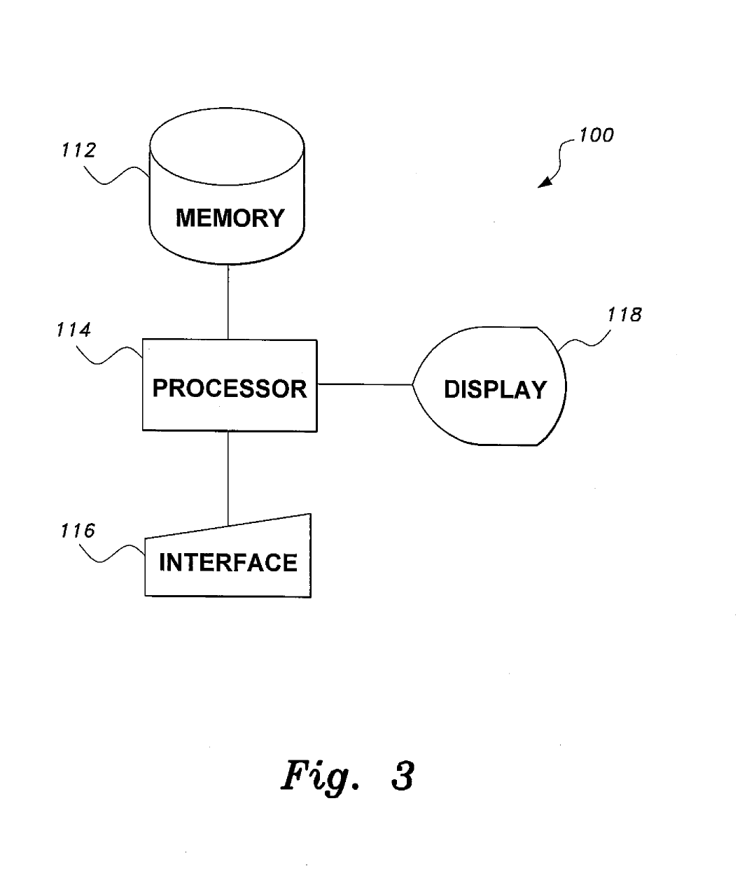

It should be understood that the calculations may be performed by any suitable computer system, such as that diagrammatically shown in FIG. 3. Data is entered into the system 100 via any suitable type of user interface 116, and may be stored in memory 112, which may be any suitable type of computer readable and programmable memory and is preferably a non-transitory, computer readable storage medium. Calculations are performed by a processor 114, which may be any suitable type of computer processor and may be displayed to the user on a display 118, which may be any suitable type of computer display.

The processor 114 may be associated with or incorporated into any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, except for transitory, propagating signals.

It is to be understood that the present invention is not limited to the embodiments described above, but encompasses any and all embodiments within the scope of the following claims.

We claim:

1. A computer software product that includes a non-transitory storage medium readable by a processor, the non-transitory storage medium having stored thereon a set of instructions for performing a method of visually indicating optimal communication times, the instructions comprising:
(a) a first set of instructions which, when loaded into main memory and executed by the processor, causes the processor to monitor at least one selected type of communication of an entity and record the number of times N the selected type of communication occurs within one hour of a particular sampling day, and to record the total number of times T the selected type of communication occurs within the sampling day;
(b) a second set of instructions which, when loaded into main memory and executed by the processor, causes the processor to calculate a percentage Pᵢ for each of the i-th hours of the sampling day, wherein i is an integer ranging between 0 and 23, indicating an hourly percentage of the total number of times the selected type of communication occurred in the sampling day as Pᵢ=(N/T)×100;
(c) a third set of instructions which, when loaded into main memory and executed by the processor, causes the processor to display a selected set of the percentages Pᵢ to a user;
(d) a fourth set of instructions which, when loaded into main memory and executed by the processor, causes the processor to assign a first unique color to any of the i hours where Pᵢ is greater than 10;
(e) a fifth set of instructions which, when loaded into main memory and executed by the processor, causes the processor to assign a second unique color to any of the i hours where Pᵢ is in the range 5≦Pᵢ≦10;
(f) a sixth set of instructions which, when loaded into main memory and executed by the processor, causes the processor to assign a third unique color to any of the i hours where Pᵢ is less than 5; and
(g) a seventh set of instructions which, when loaded into main memory and executed by the processor, causes the processor to display to the user a visual representation of a 24-hour period of the sampling day divided into 24 separate regions, each of the regions representing a corresponding one of the i hours, wherein each of the regions is displayed in the respective color of the corresponding i-th hour, wherein a region displayed in the first color indicates a desirable time period for communicating with the entity, a region displayed in the second color indicates a less desirable time period for communicating with the entity, and a region displayed in the third color indicates a least desirable time period for communicating with the entity.

2. The computer software product as recited in claim 1, further comprising an eighth set of instructions which, when loaded into main memory and executed by the processor, causes the processor to display multiple visual representations of the 24-hour period of the sampling day divided into the 24 separate regions, each of the visual representations corresponding to a unique selected entity.

3. The computer software product as recited in claim 1, further comprising a ninth set of instructions which, when loaded into main memory and executed by the processor, causes the processor to generate a reminder alert for alerting the user to communicate with the entity during the desirable time period for communicating with the entity.

4. The computer software product as recited in claim 3, further comprising a tenth set of instructions which, when loaded into main memory and executed by the processor, causes the processor to generate an email message for the user to communicate with the entity.

5. The computer software product as recited in claim 1, further comprising an eleventh set of instructions which, when loaded into main memory and executed by the processor, causes the processor to display selected communication statistical data to the user.

6. A computer software product that includes a non-transitory storage medium readable by a processor, the non-transitory storage medium having stored thereon a set of instructions for performing a method of visually indicating optimal communication times, the instructions comprising:
(a) a first set of instructions which, when loaded into main memory and executed by the processor, causes the processor to monitor at least one selected type of communication of an entity and record the number of times N the selected type of communication occurs within one hour of a particular sampling day, and to record the total number of times T the selected type of communication occurs within the sampling day;
(b) a second set of instructions which, when loaded into main memory and executed by the processor, causes the processor to calculate a percentage Pᵢ for of the i-th hours of the sampling day, wherein i is an integer ranging between 0 and 23, indicating an hourly percentage of the total number of times the selected type of communication occurred in the sampling day as Pᵢ=(N/T)×100;
(c) a third set of instructions which, when loaded into main memory and executed by the processor, causes the processor to display a selected set of the percentages Pᵢ to a user;
(d) a fourth set of instructions which, when loaded into main memory and executed by the processor, causes the processor to calculate a weighted percentage WPᵢ for each of the i-th hours of the sampling day such that when k occurrences of the selected type of communication occur within the i-th hour, a weighted number N_{w} is calculated as N_{w}=1+0.25(k−1), wherein the weighted percentage WPᵢ for the i-th hour of the particular day is calculated as WPᵢ=(N_{w}/T)×100;
(e) a fifth set of instructions which, when loaded into main memory and executed by the processor, causes the processor to assign a first color to any of the i hours where WPᵢ is greater than 10;
(f) a sixth set of instructions which, when loaded into main memory and executed by the processor, causes the processor to assign a second color to any of the i hours where WPᵢ is in the range 5≦Pᵢ≦10;
(g) a seventh set of instructions which, when loaded into main memory and executed by the processor, causes the processor to assign a third color to any of the i hours where WPᵢ is less than 5; and
(h) an eighth set of instructions which, when loaded into main memory and executed by the processor, causes the processor to display to the user a visual representation of a 24-hour period for the sampling day divided into 24 separate regions, each of the regions representing a corresponding one of the i hours, wherein each of the regions is displayed in the respective color of the corresponding i-th hour, wherein a region displayed in the first color indicates a desirable time period for communicating with the entity, a region displayed in the second color indicates a less desirable time period for communicating with the entity, and a region displayed in the third color indicates a least desirable time period for communicating with the entity.

7. The computer software product as recited in claim 6, further comprising a ninth set of instructions which, when loaded into main memory and executed by the processor, causes the processor to display multiple visual representations of the 24-hour period of the sampling day divided into the 24 separate regions, each of the visual representations corresponding to a unique selected entity.

8. The computer software product as recited in claim 6, further comprising a ninth set of instructions which, when loaded into main memory and executed by the processor, causes the processor to generate a reminder alert for alerting the user to communicate with the entity during the desirable time period for communicating with the entity.

9. The computer software product as recited in claim 8, further comprising a tenth set of instructions which, when loaded into main memory and executed by the processor, causes the processor to generate an email message for the user to communicate with the entity.

10. The computer software product as recited in claim 6, further comprising an eleventh set of instructions which, when loaded into main memory and executed by the processor, causes the processor to display selected communication statistical data to the user.

11. A computer software product that includes a non-transitory storage medium readable by a processor, the non-transitory storage medium having stored thereon a set of instructions for performing a method of visually indicating optimal communication times, the instructions comprising:
(a) a first set of instructions which, when loaded into main memory and executed by the processor, causes the processor to monitor at least one selected type of communication of an entity and record the number of times N the selected type of communication occurs within one hour of a particular sampling day of a set of sampling days belonging to a sampling week, and to record the total number of times T the selected type of communication occurs within each of the sampling days of the sampling week;
(b) a second set of instructions which, when loaded into main memory and executed by the processor, causes the processor to calculate a percentage Pᵢ for of the i-th hours of each of the sampling days, wherein i is an integer ranging between 0 and 23, indicating an hourly percentage of the total number of times the selected type of communication occurred in the sampling day as Pᵢ=(N/T)×100;
(c) a third set of instructions which, when loaded into main memory and executed by the processor, causes the processor to display a selected set of the percentages Pᵢ to a user;
(d) a fourth set of instructions which, when loaded into main memory and executed by the processor, causes the processor to calculate a weighted percentage WPᵢ for each of the i-th hours of each of the sampling days such that when k occurrences of the selected type of communication occur within the i-th hour, a weighted number N_{w} is calculated as N_{w}=1+0.25(k−1), wherein the weighted percentage WPᵢ for the i-th hour of the particular sampling day is calculated as WPᵢ=(N_{w}/T)×100;
(e) a fifth set of instructions which, when loaded into main memory and executed by the processor, causes the processor to assign a first color to any of the i hours where WPᵢ is greater than 10;
(f) a sixth set of instructions which, when loaded into main memory and executed by the processor, causes the processor to assign a second color to any of the i hours where WPᵢ is in the range 5≦Pᵢ≦10;
(g) a seventh set of instructions which, when loaded into main memory and executed by the processor, causes the processor to assign a third color to any of the i hours where WPᵢ is less than 5; and
(h) an eighth set of instructions which, when loaded into main memory and executed by the processor, causes the processor to display to the user a visual representation of a 24-hour period for each of the sampling days divided into 24 separate regions, each of the regions representing a corresponding one of the i hours, wherein each of the regions is displayed in the respective color of the corresponding i-th hour, wherein a region displayed in the first color indicates a desirable time period for communicating with the entity, a region displayed in the second color indicates a less desirable time period for communicating with the entity, and a region displayed in the third color indicates a least desirable time period for communicating with the entity.

12. The computer software product as recited in claim 11, further comprising a ninth set of instructions which, when loaded into main memory and executed by the processor, causes the processor to display multiple visual representations of the 24-hour period of a selected one of the sampling days divided into the 24 separate regions, each of the visual representations corresponding to a unique selected entity.

13. The computer software product as recited in claim 11, further comprising a ninth set of instructions which, when loaded into main memory and executed by the processor, causes the processor to generate a reminder alert for alerting the user to communicate with the entity during the desirable time period for communicating with the entity.

14. The computer software product as recited in claim 13, further comprising a tenth set of instructions which, when loaded into main memory and executed by the processor, causes the processor to generate an email message for the user to communicate with the entity.

15. The computer software product as recited in claim 11, further comprising an eleventh set of instructions which, when loaded into main memory and executed by the processor, causes the processor to display selected communication statistical data to the user.
